(19) United States
(12) Patent Application Publication
(10) Pub. No.: US 2006/0117260 A1
(43) Pub. Date: Jun. 1, 2006

(54) Grouping of representations in a user interface

(75) Inventors: David Hendler Sloo, Menlo Park, CA (US); Kevin T. Carle, Mountain View, CA (US); Michael Cleron, Menlo Park, CA (US); Samuel Thomas Scott III, Los Gatos, CA (US); Vivek Thukral, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/000,102

(22) Filed: Nov. 30, 2004

(51) Int. Cl. G06F 17/00; H04N 5/44

(52) U.S. Cl. 715/719; 715/749

(57) ABSTRACT

Grouping of representations in a user interface is described. In an implementation, a method includes distinguishing a plurality of on-demand content items from a plurality of time-dependent content items that are described in data. A plurality of linearly-arranged groupings is formed, based on the distinguishing, for output in a user interface. At least one of the groupings includes representations of time-dependent content items that are available via a particular channel. Another one of the groupings includes representations of on-demand content items that are available via plurality of channels.

### TECHNICAL FIELD

The present invention generally relates to the field of content and more particularly relates to grouping of representations in a user interface.

### BACKGROUND

Users have access to an ever increasing variety of content that may be output in a wide variety of ways. For example, a user may view traditional television programming received over a network by using a client, such as a set-top box. The user may also view pay-per-view (PPV) movies, order video-on-demand (VOD) content, interact with a video game, play music, and so on.

To navigate through this even increasing variety of content, the user may interact with user interface which displays representations of the content, such as an electronic program guide (EPG). For example, the EPG may enable the user to observe a listing of television programs that are currently being streamed, as well as a listing of television programs that will be streamed in the future. Additionally, the EPG may allow the user to navigate to a television program from the EPG itself. For instance, the user may select a representation of a television program to cause the client to tune to that television program. Additionally, to provide additional information to the user, the EPG may describe the television programs using one or more television program characteristics, such as title, start time, channel, and so on.

A traditional EPG, however, when utilized to represent the wide variety of content items now available to the user may be hindered by the “channel/time” model that is typically employed to organize television programs. For example, an output of a traditional television program is time dependent. Therefore, a user wishing to view a television program tunes to a particular channel at a particular time to view a broadcast of the television program. Television programs are typically represented in a traditional EPG via a grid having an axis which denotes time and another axis which denotes channels. Therefore, a user can readily determine a time and channel for receiving a broadcast of a particular television program when viewing the EPG.

Content items, however, may be configured for output in a wide variety of other ways, such as “on-demand”. On-demand content items are configured for time-independent output so that a user can interact with the on-demand content item whenever desired. For instance, certain content types are most frequently distributed in an “on-demand” format, such as on-line purchasable music and rental videos, and thus may be thought of as “non-time based”. Other types of content are most frequently distributed in a time-based mode, such as scheduled video and radio programming. This type of content item may be referred to as “time based”. It should be noted that most individual content items, such as a movie or a music album, may be distributed in a “time-based and/or “on-demand” format. When a traditional EPG displays “on-demand” content, however, the on-demand content items are typically displayed within the time/channel grid through representations that are repeated for that particular channel. The repeated representations may therefore give a user a false sense of time-dependency for output of the on-demand content items.

Even in an instance in which output of each of the described content items in an EPG is time dependent, some content items may be repeated on a particular channel. For example, a single pay-per-view (PPV) movie may be repeatedly broadcast on a channel. Therefore, to describe the PPV in a traditional EPG, the channel may include redundant representations to denote the various times the PPV movie is available, thereby resulting in an inefficient utilization of display area available for the EPG.

Therefore, there is a continuing need for grouping of representations of non-time based content in a user interface.

### SUMMARY

Grouping of representations for display in a user interface is described. A user interface, such as an EPG, may group representations (e.g., cells, icons, thumbnails, and so on) of content items by utilizing a variety of criteria to optimize the display of the user interface. For example, matching content representations for content items that are available on a single channel may be grouped for display as a single representation. The single channel, for instance, may include generic representations of content items, such as “news” for a news channel. Therefore, even though the content items themselves may be unique, the representations are not, and therefore may be grouped to form a single representation of the plurality of content items, thereby conserving display space in the user interface.

In another example, matching content representations for content items that are available on consecutive channels are grouped for display in a single grouping of representations. For instance, a plurality of channels may be utilized to stream the same movie at staggered times. Therefore, the representations of the movie may be grouped together (e.g., interleaved in a linear grouping) such that a user, when viewing the user interface, may be presented with a chronological ordering of when the movie is available without having to navigate through the separate channels.

In a further example, representations of on-demand content items are grouped together and representations of time-dependent content items are grouped together. As previously described, content items may have an output type, such as “on-demand” for content items that are available to the client whenever desired, and “time-dependent” for content items that are available to the client at specific, pre-determined times. To optimize the user interface for display of representations of the various output types of content, representations of time-dependent content items may be grouped such that each is provided with a “channel/time” indication. Representations of on-demand content items may also be grouped such that a specific “time” indication is not provided. For example, on-demand content may be grouped into an “on-demand” category, may be grouped into a plurality of groupings (e.g., “action”, “comedy”, “drama”, and so on), and so forth. Thus, the user interface enables the use to distinguish between the different output types. Further, the groups may be utilized for more efficient utilization of space in the electronic program guide. For example, an “action” grouping of a plurality of movies may be provided instead of use of separate channel/movie combinations for each movie. A variety of other criteria may also be employed to form grouping of representations to optimize a user interface, such as representations for staggered channel lineups, user-configured groupings, and so on.

### BRIEF DESCRIPTION OF THE DRAWINGS

FIG. 1 is an illustration of an environment in an exemplary implementation that includes a content provider that is communicatively coupled to a client over a network.

FIG. 2 is an illustration of an exemplary implementation of a system showing a distribution server and the client of FIG. 1 in greater detail.

FIG. 3 is an illustration of an exemplary implementation of a system showing exemplary EPG data as stored by the client of FIG. 2.

FIG. 4 is an illustration of an exemplary implementation showing the EPG formed from the EPG data depicted in FIG. 3 through execution of the EPG module.

FIG. 5 is a flow diagram depicting a procedure in an exemplary implementation in which the EPG module is executed on the client to derive groupings of described content items in EPG data for generating the EPG.

FIG. 6 is a flow diagram depicting a procedure in an exemplary implementation in which an EPG is generated having representations that are grouped based on an output type of the represented content item.

FIG. 7 is a flow diagram depicting a procedure in an exemplary implementation in which representations of content items that match are interleaved for display in an EPG.

The same reference numbers are utilized in instances in the discussion to reference like structures and components.

### DETAILED DESCRIPTION

Overview

Grouping of representations in a user interface is described. Groupings may be employed to optimize the user interface in a variety of ways. For example, the user interface may be configured as an electronic program guide (EPG) having a plurality of representations (e.g., cells, icons, thumbnails, etc.) of content items. Representations of matching content items available for output via consecutive channels may be combined into a single linear grouping (e.g., a row or column) for the consecutive channels, such as via a pop-up list, a pull-down menu, and so on. Content items and/or channels may “match”, one to another, in a variety of ways. For example, content on each of the channels may have a matching type, such as “on-demand”. Additionally, the content items themselves may match, such as through provision of the same pay-per-view (PPV) movie. Further, the description of each channel may not vary over time, such as a news channel having a generic description.

A variety of techniques may be employed to form a single linear grouping. For instance, consecutive channels for output in an EPG may represent pay-per-view (PPV) movies having different respective start times. Representations for the PPV movies may be combined into a single linear column (e.g., interleaved), thereby representing both of the consecutive channels. On the other hand, consecutive channels which do not have matching representations are each represented via a corresponding linear grouping. Therefore, each channel having unique content may be provided with a single linear grouping, while channels having matching content items are combined, thereby optimizing the EPG.

In another example, generic representations of content items are combined to form a single grouping. For instance, news and weather programs typically provide repeating generic descriptions of content items, such as “headline news”, “weather forecast”, and so on. Representations having the generic descriptions may be combined into one or more groupings to conserve space utilized to display the EPG, such as by displaying a single representation for each news channel together with other such representations. Thus, the user is able to navigate through such an EPG without being presented with redundant data that is often ignored by the user, thereby improving the viewing experience.

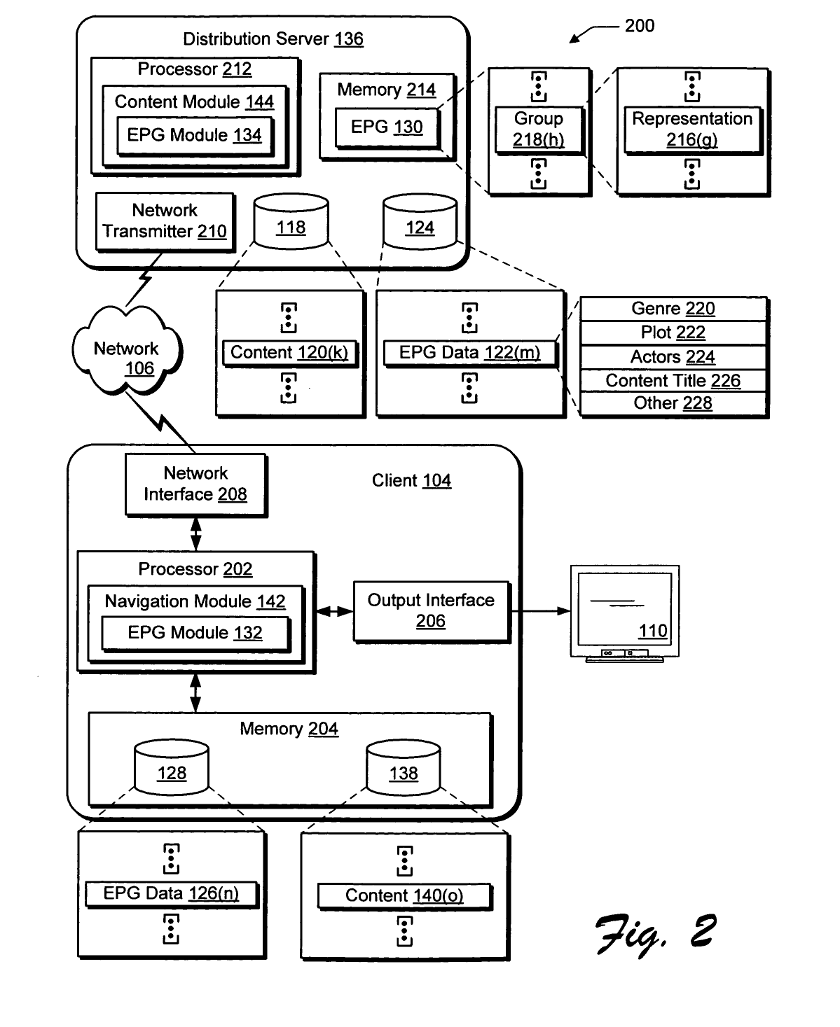

In a further example, representations of content items are grouped for display in a user interface based on output type. As previously described, a user may utilize a client (e.g., a set-top box) to access content that is available for output whenever desired (i.e., on-demand content) and content that is available for output during a specific period of time (i.e., time-dependent content). The user interface may be configured to address these different output types to improve the viewing experience of the user. For instance, representations of time-dependent content may positioned to indicate a relative start time and channel for obtaining the time-dependent content. Representations of on-demand content, however, may be combined into one or more groupings in the user interface such that an indication of a channel for obtaining the on-demand content items is provided, but an indication of a specific time is not provided. For instance, although the EPG may be configured to show content that is available during a particular day, the EPG does not show a particular time of day for accessing on-demand content. Thus, a user, when viewing the user interface is not confused as to which of the representations correspond to on-demand content and which of the representations correspond to time-dependent content. A variety of other characteristics of representations and/or the represented content items may be utilized to form groupings, further discussion of which may be found in relation to FIG. 2.

Exemplary Environment

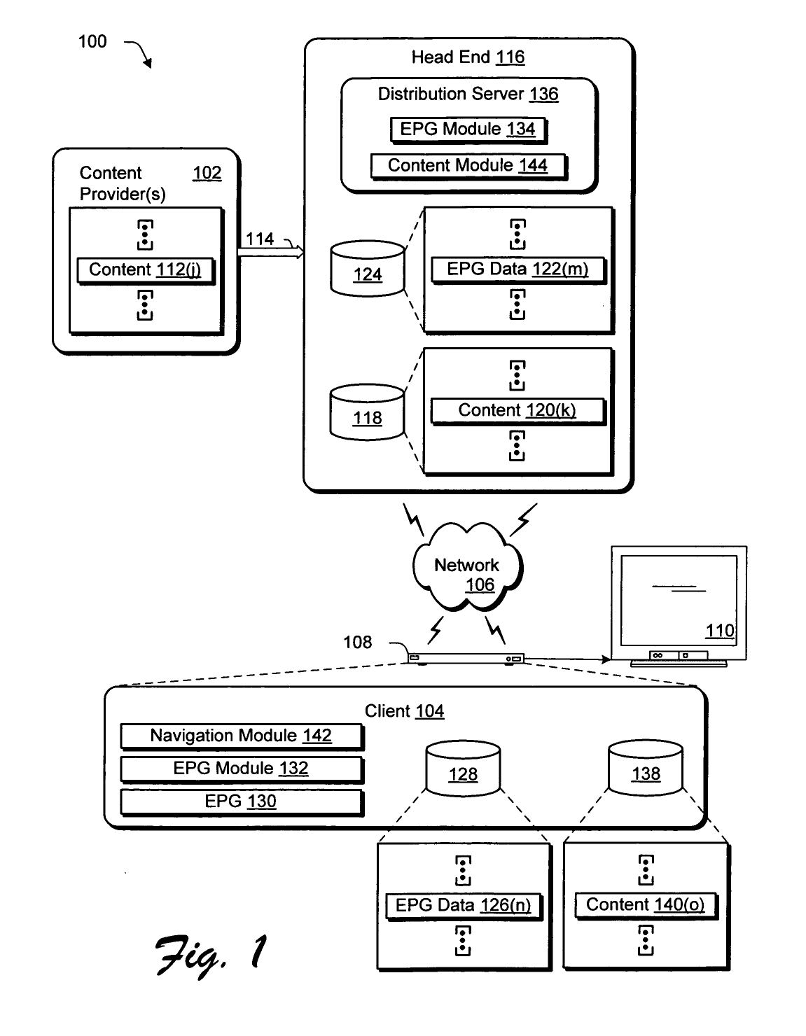

FIG. 1 is an illustration of an environment 100 in an exemplary implementation that includes a content provider 102 that is communicatively coupled to a client 104 over a network 106. The client 104 may be configured in a variety of ways. For example, the client 104 may be configured as a computing device that is capable of communicating over the network 106, such as a desktop computer, a mobile station, an entertainment appliance, a set-top box 108 communicatively coupled to a display device 110 as illustrated, a wireless phone, and so forth. The client 104 may range from a full resource device with substantial memory and processor resources (e.g., television enabled personal computers, television recorders equipped with hard disk) to a low-resource device with limited memory and/or processing resources (e.g., traditional set-top boxes). The client 104 may also relate to a person and/or entity that operates the client. In other words, client 104 may describe a logical client that includes a user and/or a machine. Although one client 104 is illustrated, a plurality of clients may be communicatively coupled to the network 106. Likewise, although one content provider 102 is illustrated, a plurality of content providers may also be included in the environment 100. The network 106 is illustrated as the Internet, and may include a variety of other networks, such as an intranet, a wired or wireless telephone network, a broadcast network which may include a backchannel to provide two-way communication, and so forth.

The content provider 102 includes a plurality of content 1120), where “j” can be any integer from 1 to “J”. The content 1120) may include a variety of data, such as streaming content (e.g., television programming and pay-per-view movies), one or more results of remote application processing, and so on. The content 1120) is communicated over a network 114 to a head end 116, which may act as a data center which services a plurality of clients. The network 114 may be the same as or different from network 106. For example, the network 114 may be configured as a private subnet while the network 106 is configured as the Internet.

Content 1120) communicated from the content provider 102 over the network 114 is received by the head end 116 and stored in a storage device 118 as content 120(k), where “k” can be any integer from “1” to “K”. The content 120(k) may be the same as or different from the content 1120) received from the content provider 102. The content 120(k), for instance, may include additional data for streaming to the client 104, may be compressed using one or more data compression techniques by the head end 116, may be encrypted, and so forth.

The head end 116 may also include a plurality of EPG data 122(m), where “m” can be any integer from one to “M”. The plurality of EPG data 122(m) is stored in an EPG database 124 for communication to the client 104. Although illustrated separately, the EPG database 124 and the storage device 118 that is used to store the content 120(k) may be implemented utilizing the same system. In an implementation, the EPG data 122(m) is broadcast utilizing a carousel file system. The carousel file system repeatedly broadcasts the EPG data 122(m) over an out-of-band (OOB) channel to the client 104 over the network 106. The client 104 may then store the broadcast EPG data 122(m) received over the network 106 as EPG data 126(n), where “n” can be any integer from one to “N”, in a database 128. To generate an EPG 130, the client 104 executes an EPG module 132 that examines and configures the EPG data 126(n) into a form that suitable for output to and rendering by the display device 110.

In another implementation, the EPG 130 is formed from the EPG data 122(m) at the head end 116 and then distributed to the client 104. For example, the head end 116 may also include an EPG module 134 that is executable on a distribution server 136 to generate the EPG 130 from the EPG data 122(m). The EPG 130 may be configured in a variety of ways through execution of the EPG module 134 at the head end 116, such as a particular EPG for each particular client that is communicatively coupled to the head end 116, a generic EPG representing each item of content 120(k) (which will also be referred to in the following discussion as a “content item”), and so on. Distribution from the head end 116 to the client 104 may be accommodated in a number of ways, including cable, RF, microwave, digital subscriber line (DSL), and satellite.

The client 104 may be configured in a variety of ways to receive the content 120(k) over the network 106. As illustrated, the client 104 may be configured as a set-top box 108 that is communicatively coupled to a display device 110. The client 104 includes hardware and software to transport and decrypt content 120(k) received from the head end 116 for rendering by the display device 110. Although a display device 110 is shown, a variety of other output devices are also contemplated, such as speakers.

The client 104 may also include digital video recorder (DVR) functionality. For instance, the client 104 may include a storage device 138 to record the content 120(k) received from the network 106. The storage device 138 may be configured in a variety of ways, such as a hard disk drive, a removable computer-readable medium (e.g., a writable digital video disc), and so on. Content 140(o), where “o” can be any number from “1” to “0”, that is stored in the storage device 138 of the client 104 may be copies of the content 120(k) that was streamed from the head end 116. Additionally, content 140(o) may represent content obtained from a variety of other sources, such as from a computer-readable medium that is accessible by the client 104.

The client 104 includes a navigation module 142 that is executable on the client 104 to control content playback on the client 104, such as through the use of one or more “trick modes”. The trick modes may provide non-linear playback of the content 140(o) (i.e., time shift the playback of the content 140(o)) such as pause, rewind, fast forward, slow motion playback, and the like. For example, during a pause, the client 104 may continue to record the content 120(k) in the storage device 118 as content 140(o). The client 104, through execution of the navigation module 142, may then playback the content 140(o) from the storage device 138, starting at the point in time the content 140(o) was paused, while continuing to record the currently-broadcast content 120(k) in the storage device 138 from the head end 116.

When playback of the content 140(o) is requested, the navigation module 142 may be executed on the client 104 to retrieve the content 140(o). The navigation module 142 may also restore the content 140(o) to the original encoded format as received from the content provider 102. For example, when the content 120(k) is recorded on the storage device 138 to form content 140(o), the content 120(k) may be compressed. Therefore, when the navigation module 142 retrieves the content 140(o), the content 140(o) is decompressed for rendering by the display device 110.

The navigation module 142 may also be executed on the client 104 to retrieve content 120(k) stored on the head end 116. For example, the navigation module 142 may communicate with a content module 144 that is executable on the distribution server 136 to cause recordation of content 112(j) received from the content provider 102 as content 120(k). In this instance, the content module 144 provides network digital video recorder (NDVR) functionality in a manner similar to a DVR. For instance, the content module 144 may support one or more trick modes to fast forward, pause, perform slow-motion playback, and so on in a manner similar to playback of the content 140(o) that is stored locally on the client 104. The navigation module 142 may also communicate with the content module 144 to order on-demand content (e.g., VOD, Subscription Video On Demand (SVOD)), PPV content, and so on. Thus, the environment 100 may support a wide variety of content, such as VOD, PPV, locally-stored content 140(o), remotely-stored content 120(k), television programs, video games, music, and so on. This variety of content may be grouped for display in a user interface, e.g., the EPG 130, in a variety of ways, further discussion of which may be found in relation to FIG. 2.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, further description of which may be found in relation to FIG. 2. The features of the grouping strategies described below are platform-independent, meaning that the grouping strategies may be implemented on a variety of commercial computing platforms having a variety of processors.

FIG. 2 is an illustration of an exemplary implementation of a system 200 showing the distribution server 136 and the client 104 of FIG. 1 in greater detail. The client 104 includes a processor 202 and memory 204. The navigation module 142 is illustrated as being executed on the processor 202 and is storable in memory 204. The storage device 138, which is utilized to store the plurality of content 140(o), is illustrated as included in the memory 204. Likewise, the database 128 which is used to store the plurality of EPG data 126(n) is also illustrated as included in the memory 204. Although illustrated together, the memory 204 may be different from either one or both of the database 128 and storage device 138. For example, the database 128 and storage device 138 may be implemented as a hard disk drive and RAM, both may be configured as RAM, one may be configured as a removable memory device, and so forth.

As shown in the environment 100 of FIG. 1, the client 104 may obtain content from a variety of sources. For example, the client 104 may execute the navigation module 142 to retrieve content 140(o) from the storage device 138. The retrieved content 140(o) may then be output using an output interface 206 for rendering on the display device 110. The client 104, through execution of the navigation module 142, is also capable of requesting content 120(k) from the distribution server 136 over the network 106. The distribution server 136 is represented pictorially as including the storage device 118 having the plurality of content 120(k) for streaming over a network 106. The distribution server 136 may provide EPG data 122(m) from the EPG database 124 that describes content available from other content provider 102 of FIG. 1.

The navigation module 142, when executed on the processor 202, may send a request via the network 106 to the distribution server 136 to request content 120(k) for streaming over the network 106, such as a PPV movie, VOD, and so forth. The client 104 includes a network interface 208 to communicatively couple the client 104 with the distribution server 136. As previously described, the network 106 may support two-way communication between the distribution server 136 and the client 104. Additionally, the network 106 can be any type of network, using any type of network topology and any network communication protocol, and can be represented or otherwise implemented as a combination of two or more networks including, for example, microwave, satellite, and/or data networks, such as the Internet. Furthermore, the network 106 may be capable of transmitting and receiving wired or wireless media using any broadcast format or broadcast protocol.

The distribution server 136 also includes a network transmitter 210 (hereinafter “transmitter”). The transmitter 210 may distribute the content 120(k) of FIG. 1 from the storage device 118, the EPG data 122(m) from the EPG database 124, and so on. In alternate implementations, the distribution server 136, storage device 118, EPG database 124, and the transmitter 210 may be implemented as one or more distinct components, locally as part of the head end 116 and/or content provider 102 of FIG. 1, or remotely as part of another distinct system. For instance, although the distribution server 136 is shown as including the EPG module 134 and content module 144 (which are executable for distribution of content 120(k), distribution of the EPG data 122(m), and/or generation of the EPG 130 as previously described), each component and its corresponding functionality may be implemented via a distinct device, such as a server. Accordingly, the distribution server 136 may represent a plurality of servers which provide the functionality.

The distribution server 136 also includes a processor 212 and memory 214. The content module 144 is illustrated as including the EPG module 134, which are both illustrated as being executed on the processor 212 and are storable in memory 214. The EPG module 134 is illustrated as within the content module 144 to portray that both modules may be implemented together, although both modules may also be implemented separately as “stand-alone” modules as shown in FIG. 1.

The content module 144, when executed, controls distribution of the EPG data 122(m) from the EPG database 124 over the network 106. EPG data 122(m) may include any data that may be utilized to generate an EPG, such as obtained from the content provider 102 which describes the provided content, metadata included with content 140(o) stored on the storage device 138 as previously described in the DVR example, and so on.

The content module 144 may also control distribution of the content 120(k) over the network 106 as previously described. For instance, the content module 144 may receive a request from the client 104 to receive the content 120(k). The content module 144 processes the request, such as to determine whether the client 104 is permitted to receive the content 120(k) (e.g., the client 104 has obtained conditional access rights to the content), obtain billing information from the client 104, locate the requested content from the plurality of content 120(k), and so on. If the client 104 is permitted to receive the content 120(k), the content module 144 may be executed to stream the content 120(k) to the client 104 over the network 106 by using the transmitter 210. In this instance, the content 120(k) is provided from the distribution server 136 in response to the request, and therefore is provided “on-demand” to the client 104. Examples of on-demand content items include VOD, games, content that is locally stored via a DVR or remotely via a NDVR, and so on. Thus, the output of on-demand content is time independent and may be preformed by the client 104 when desired.

Time-dependent content items, on the other hand, are obtained by the client 104 during specific periods of time (i.e., are time specific). For example, a broadcast of a television program is time-dependent in that the television program is typically broadcast by a particular channel at a particular time. PPV (pay-per-view) movies may also be time-dependent. For example, a plurality of channels may each provide the same pay-per-view movie so that a user does not have to wait until the completion of a broadcast of the movie on a single channel. For example, three channels may be used to broadcast a one and a half hour movie at staggered half-hour intervals so that a user need only wait a maximum of one half hour to begin watching the PPV movie.

Output of a content item may not depend on the content item itself, such that the content item may be provided either as “on-demand” or “time-dependent” as desired. For example, music may be provided “on-demand” for download by the client 104 whenever desired. Music may also be broadcast, such that particular songs are provided during specific periods of time. In this way, each content item may have an output type which defines whether an output of the content item is time-dependent or time-independent (i.e., on-demand) which is independent from whatever particular category (e.g., music, movie, and so on) the content item is included.

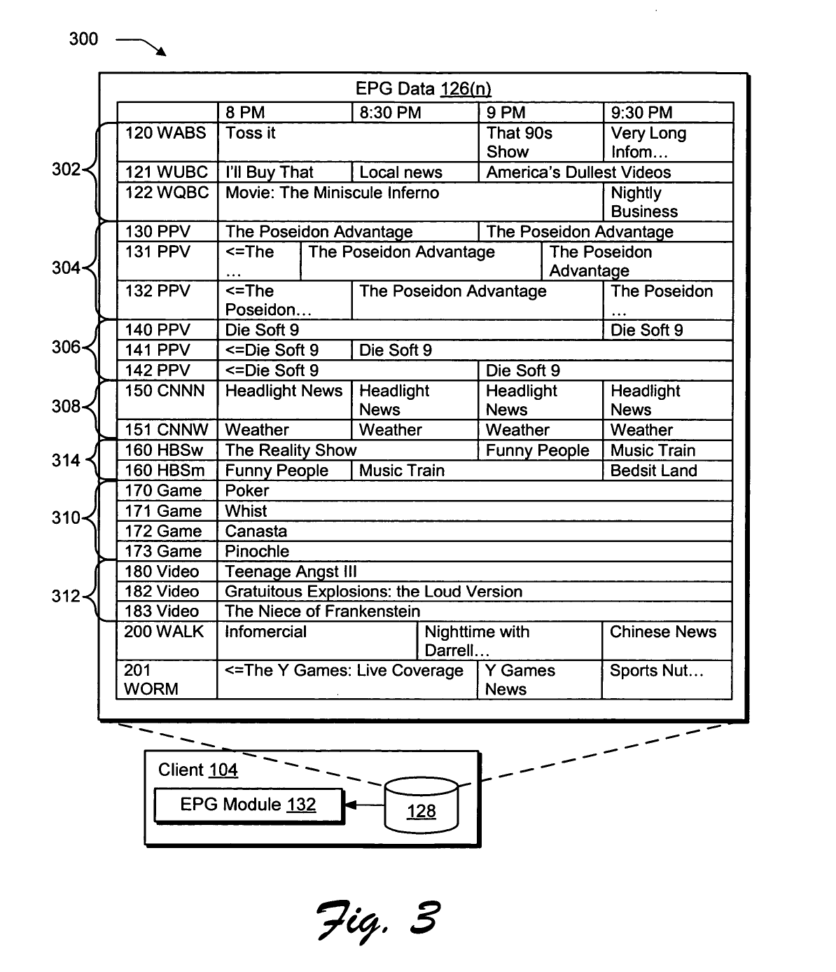

The EPG module 134, when executed, may generate the EPG 130 such that it is optimized depending on the content items described in the EPG, such as by grouping representations of content items. For example, the EPG 130 may include a plurality of representations 216(g), where “g” can be any integer from one to “G”, of the content 120(k) of FIG. 1. Each representation 216(g) corresponds to at least one of the plurality of content 120(k), i.e., a respective content item. The plurality of representations 216(g) may be arranged into one of a plurality of groups 218(h), where “h” can be any integer from one to “H”, depending on the output type (e.g., on-demand versus time dependent). By arranging the plurality of representations 216(g) into groups 218(h), the EPG 130 may be optimized for display of the various output types. For example, groups of representations of time-dependent content items may be displayed together in a time/channel grid and groups of representation of on-demand content items may be displayed in columns with corresponding channels but without corresponding time indications. Therefore, the EPG, when viewed by the user, provides a readily recognizable distinction between on-demand and time-dependent content items. Further discussion of groups of representations that are formed based on output type may be found beginning in relation to FIG. 3.

The plurality of representations 216(g) in the EPG 130 may also be formed into the plurality of groups 218(h) based on a variety of characteristics of the described content 120(k), 140(o). For example, the EPG data 122(m) may describe characteristics of the content 120(k), such as genre 220, plot 222 (e.g., detailed textual description of the plot of the corresponding content 120(k)), actors 224 included in the content 120(k), content title 226, and other 228 descriptive data. The other 228 descriptive data, for instance, may identify a corresponding channel that broadcasts the content, a time at which the content is available via a broadcast, a price for obtaining the content, a content owner (e.g., production company), a content type (e.g., on-demand, time-dependent), a content category (e.g., music, movie, television program, VOD), and so on. These characteristics may be further used to form additional groupings, such as a first grouping having on-demand content items having a rating of “G” and a second group of on-demand content items having a rating of “PG”, and so on. Thus, “virtual channels” may be provided based on a variety of characteristics, such as rating, genre, and so forth. 100451 Representations 216(g) formed from EPG data 122(m) that describe matching characteristics may be utilized to optimize the EPG 130. For example, consecutive channels may have matching content which is scheduled for staggered output, such as the three channels which provide staggered broadcasts of a PPV movie as previously described. Therefore, representations of the consecutive channels may be grouped to describe the combined consecutive channels, thereby optimizing the display area of the EPG 130. A variety of other characteristics may be utilized to form the groups 218(h), such as generic representations, repeating representations, and so on, further examples of which are described in relation to the following figures.

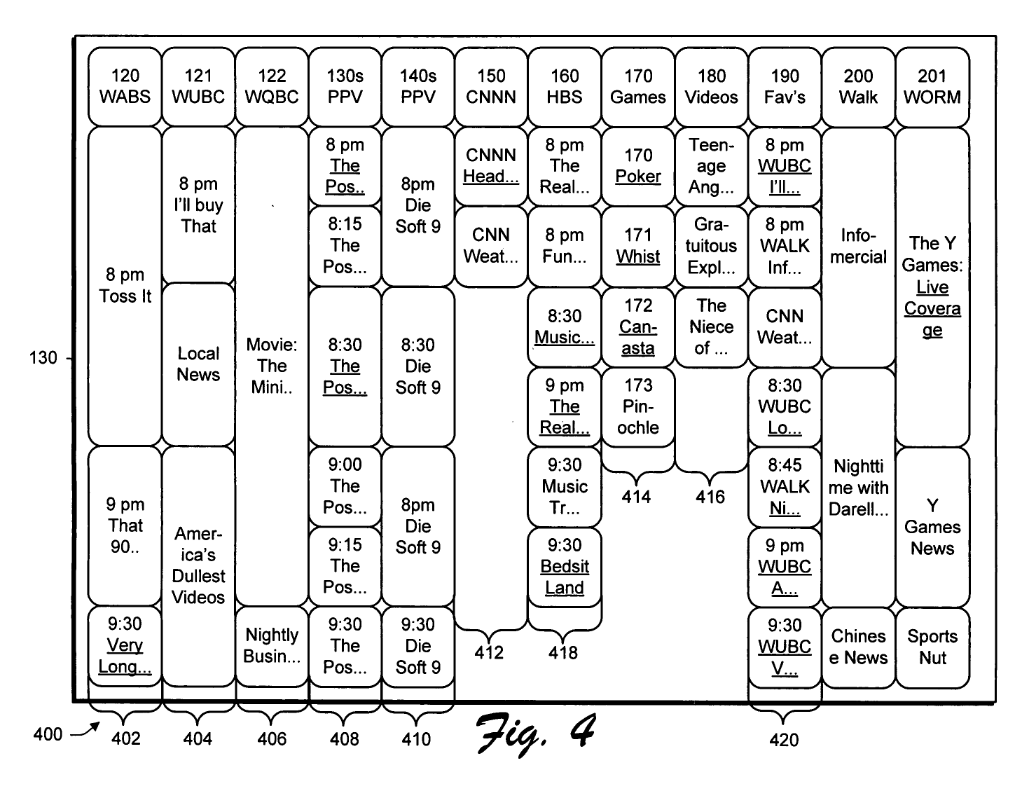

FIG. 3 is an illustration of an exemplary implementation of a system 300 showing the client 104, the EPG module 132, the EPG database 128, and the EPG data 126(n) of FIG. 2 in greater detail. FIG. 4 is an illustration of an exemplary implementation 400 showing the EPG 130 formed from the EPG data 126(n) depicted in FIG. 3 through execution of the EPG module 132. The following discussion will make reference to both FIGS. 3 and 4, with the first number of the reference numbers indicating the corresponding figure (e.g., reference number 302 and FIG. 3, reference number 402 and FIG. 4, and so on). Although execution of the EPG module 132 on the client 104 is described in relation to the following figures, the EPG module 134 of FIG. 2 may be executed on the head end 116 to provide similar functionality.

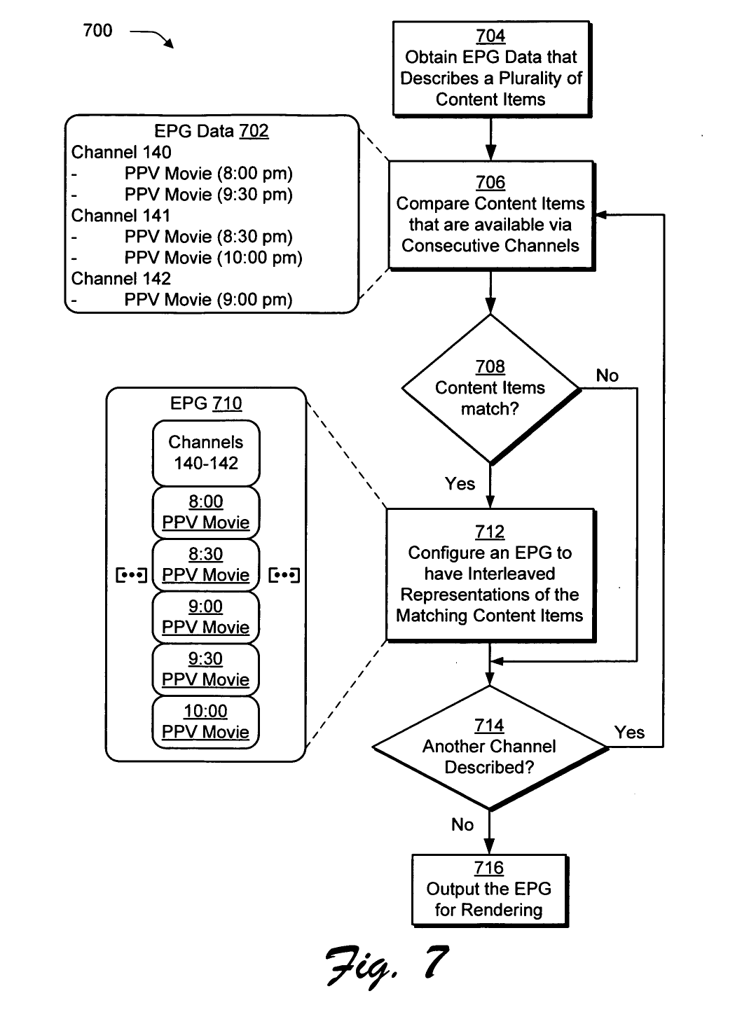

The EPG data 126(n) is represented pictorially in the system 300 of FIG. 3 as a graph which indicates a time and channel for ease of discussion. Although the EPG data 126(n) is illustrated in a manner similar to the scheme used by traditional EPGs to represent content, the EPG data 126(n) may be configured in a variety of ways to denote the characteristics of the content items described by the EPG data 126(n), a further example of which is described and shown in relation to FIG. 7. Examples of exemplary criteria which may be utilized to form the groupings are described in the following sections.

Uniquely-Scheduled Content

The EPG module 132, when executed on the client 104, examines the EPG data 126(n) to identify one or more groupings of representations which may be formed for display in the EPG 130. For example, the EPG module 132, when executed, may identify uniquely-scheduled content 302 for broadcast on channels 120-122. For instance, the EPG data 126(n) indicates that channel 120 includes television programs that do not match television programs on adjacent channel 121, such as by having unique descriptions and broadcast times. Likewise, content items described for channel 121 does not have matching descriptions for channels 120 or 122. Therefore, each of the channels having uniquely-scheduled content 302 is arranged in a separate linear grouping 402, 404, 406 in the EPG 130. Each content item (e.g., television program) in the linear groupings 402-406 is represented as a cell in the EPG 130, each having a title of the television program and a time at which the television program may be received via broadcast. Although each linear grouping 402, 404, 406 is illustrated as a column in FIG. 4, other linear groupings may also be utilized, such as rows, vectors, and so on.

Staggered, Matching Content

The EPG module 132, when executed, may also examine the EPG data 126(n) for staggered scheduled content 304 that matches, one to another. For example, the EPG module 132 may locate descriptions of content items on consecutive channels 130, 131, and 132 in the EPG data 126(n). Each of the channels 130, 131, 132 provides an output of a PPV movie that is staggered, such that the movie starts at 8 pm on channel 130, 8:15 pm on channel 131, 8:30 pm on channel 132, 9 pm on channel 130, and so on. In other words, channels 130-132 have matching content items, the output of which is time shifted by fifteen minutes. Therefore, the EPG module 132, when executed, groups representations for channels 130-132 into a single linear grouping 408 in the EPG 130, thereby optimizing space in the EPG 130. The single linear grouping 408 of the staggered scheduled content 304 includes a representation of each content item as a cell having a title and time that the represented content item is available.

Another similar linear grouping 410 may also be generated by the EPG module 132 for channels 140-142 which are identified as another collection of staggered scheduled content 306. Each of the linear groupings 408, 410 include an identifier which indicate a set of channels which provide the represented content items. For example, linear grouping 408 includes a channel identifier depicted as “130s PPV” to indicate that that particular PPV movie is available from that channel range. Because each of the representations in the linear grouping 408 is configured such that the user may select the representation to navigate to the represented content item, specific channel identifiers (i.e., the particular channel providing the particular content item) are not needed. Therefore, the channel identifiers are consolidated into a channel identifier which represents a range of channels.

Regularly-Spaced, Scheduled Matching Content

The EPG module 132, when executed, may also examine the EPG data 126(n) to locate regularly-spaced scheduled content 308 available from a single channel which supplies content having matching descriptions, one to another. In the previous examples, matching content items available from consecutive channels were combined into a linear grouping 412. Matching content items available via a single channel may also be grouped to optimize the EPG 130.

Channel 150, for example, may include repeated representations to describe a news broadcast. In this example, each of the representations is generic in that it does not describe specific characteristics of the content (e.g., particular news stories) but rather generically describes a news cast (e.g., current news). Likewise, channel 151 generically describes a weather report such that specific characteristics of the weather report are not described (e.g., a particular forecast) but rather that a weather forecast is available on that channel. Therefore, even though channels 150, 151 output content items that are unique (e.g., different weather forecasts, different news stories), the description of the content items is not. Therefore, the EPG module 132 may be executed to combine the representations of generic content items into a single linear grouping 412 in the EPG 130. The single linear grouping 412 includes a single cell that corresponds to the plurality of content items of channel 150, and another cell that corresponds to the plurality of content items of channel 151. Therefore, each of the cells may be thought of as representing the respective channels as a whole.

In another example of regularly spaced, scheduled, matching content, content items may be grouped based on a common content provider. For example, a single content provider may provide a news channel and a weather channel. The EPG module 132, when executed, may combine these channels to form a single grouping for viewing by the user.

Output Type

As previously described, content may have different output types, such as “on-demand” content that is available for output whenever desired, and “time-dependent” content that is available for output during a specific period of time. The representations may be grouped in the EPG 130 according to the output type to optimize the EPG 130.

The EPG module 132, when executed, may examine the EPG data 126(n) to locate content that is available “on-demand”. For example, the EPG data may locate channels which describe applications 310 (e.g., games illustrated as “Poker”, “Whist”, “Canasta”, and “Pinochle” in FIG. 3) available via corresponding channels (e.g., channels 170-173). Based on the examination, the EPG module 132 generates a representation for each application (e.g., game), and groups the representation in a single linear grouping 414 in the EPG 130. The linear grouping 414 may include a channel range identifier for generally indicating the channel range, from which, the applications are available. In this way, each of the applications is represented via a single corresponding representation to indicate the availability of the game, but does not indicate a particular time. For instance, each representation (illustrated as a cell in FIG. 4) in the linear grouping 414 includes a title of the game, but does not include an indication of a specific time as was provided in the previous linear groupings 402-412. Thus, a user is not confused regarding the output type of the represented content items. Although games have been described, a wide variety of on-demand applications may be provided for grouping, such as browsers, email applications, and so forth. For example, application may be grouped based on type (e.g., an application) as well as subtype (e.g., game, administrative tools, and so on). Similar techniques may be utilized to group other on-demand content. For example, time-independent video content 312 (e.g., VOD) available via channels 180, 182, and 183 may also be represented in the EPG 130 in a single linear grouping 416 of representations of the content items. The time-independent video content may also be grouped by subtype, such as “genre”.

Scheduled, Time-Shifted Content

In the linear groupings 408, 410, content items were represented from channels in which each representation on the channel matches, one to another. Groupings may also be formed to optimize the EPG 130 based on matching content lineups 314 provided by adjacent channels. For example, two “channel 160” may be described in the EPG data 126(n) for two different time zones. Thus, as illustrated in FIG. 3, a content lineup on the first channel 160 may be shifted ahead one hour in relation to a second channel 160. The EPG module 132 may be executed to generate the EPG 130 to have a single linear grouping 418 of representations of content items available on both channels. For instance, the linear grouping 418 may include interleaved representations of the content items, each indicating a specific time the content item is available from a broadcast.

Other Criteria

The EPG module 132 may be executed to generate linear groupings of representations based on a wide variety of other criteria. For example, the EPG 130 may be configured to include a linear grouping 420 of favorite content items utilized by the user. For example, the EPG module 132 may dynamically track user interaction with content and provide a representation for content items receiving the most interaction in the linear grouping 420. In another example, the user may manually select particular content items for representation in the linear grouping 420. In a further example, the content provider 102 of FIG. 1 may provide pre-configured groupings of representations. For instance, the content provider 102 may configure a grouping based on content from that particular provider, such as a family of commonly-owned broadcast stations, related broadcasts (e.g., a collection of movie channels), and so on. As previously described, although linear groupings arranged in columns are illustrated in FIG. 4, the EPG 130 may include a wide variety of different groupings. Additionally, although content that is available remotely over a network has been described, the EPG 130 may also described locally available content. For instance, the content 140(o) of FIG. 1 which is stored locally at the client 104 may include metadata which may be utilized to generate the EPG 130.

Exemplary Procedures

The following discussion describes grouping techniques that may be implemented utilizing the previously described systems and devices. Aspects of each of the procedures may be implemented in hardware, firmware, or software, or a combination thereof. The procedures are shown as a set of blocks that specify operations performed by one or more devices. The procedures are not necessarily limited to the orders shown for performing the operations by the respective blocks.

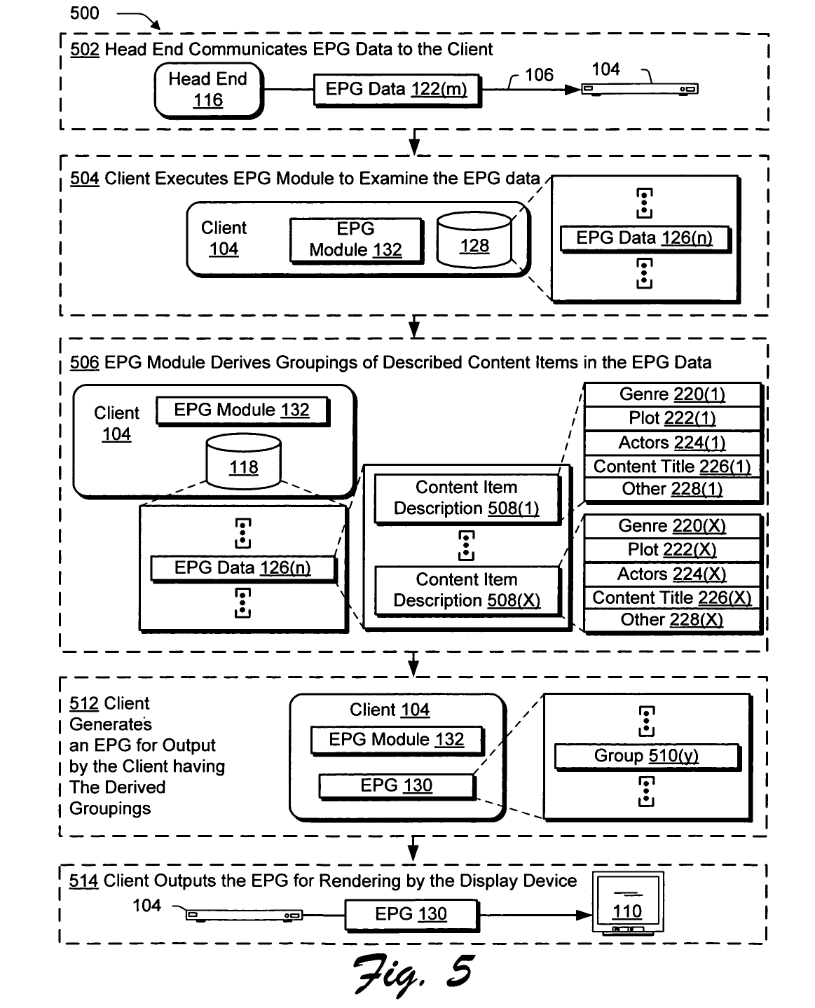

FIG. 5 is a flow diagram depicting a procedure 500 in an exemplary implementation in which the EPG module 132 is executed on the client 104 to derive groupings of described content items in EPG data for generating the EPG 130. The head end 116 communicates EPG data 122(m) to the client 104 over the network 106 (block 502). The EPG data 126(n) may be communicated in a variety of ways, such as through a carousel file system, streamed with content, and so on.

The EPG data 122(m), when received at the client 104, is stored in the EPG database 128 as EPG data 126(n). The client 104 then executes the EPG module 132 to examine the EPG data 126(n) (block 504). For example, the EPG module 132 may be executed to derive groupings of described content items in the EPG data 126(n) (block 506). The EPG data 126(n) includes a plurality of content item descriptions 508(1), . . . , 508(X). Each content item description 508(1)-508(X) describes one or more characteristics of a content item. For instance, content item description 508(1) may describe characteristics of a first content item, such as genre 220(1), plot 222(1), actors 224(1), content title 226(1), and other 228(1) characteristics, such as output type (e.g., on-demand versus time dependent). Likewise, content item description 508(X) may describe characteristics of another content item, such as a genre 220(X), plot 222(X), actors 224(X), content title 226(X), and other 228(X) characteristics.

The EPG module 132, when executed, may compare the plurality of content item descriptions 508(1)-508(X), one to another, to find matching characteristics which may be utilized to optimize an EPG. For example, the EPG module 132 may identify a plurality of generic content item descriptions for a particular channel. In another example, the EPG module 132 may identify matching content item descriptions 508(1)-508(X) for content available on consecutive channels. In a further example, the EPG module 132 may distinguish content item descriptions 508(1)-508(X) for on-demand versus time dependent output. In yet a further example, the EPG module 132 may identify staggered channel lineups that are available via consecutive channels. A variety of other matching characteristics may be utilized to derive groups of representations of content items.

The EPG module 132 may then generate the EPG 130 based on the derived groupings 510(y), where “y” can be any integer from one to “Y”, for output by the client 104 (block 512). For example, the EPG module 132 may group representations for generic content item descriptions. In another example, the EPG module 132 may group representations for matching content item descriptions 508(1)-508(X) for content available on consecutive channels. In a further example, the EPG module 132 groups representations of on-demand content separately from representations of time-dependent content. In yet a further example, the EPG module 132 groups staggered channel lineups that are available via respective channels. The client 104 may then output the EPG 130 for rendering by the display device 110 (block 514).

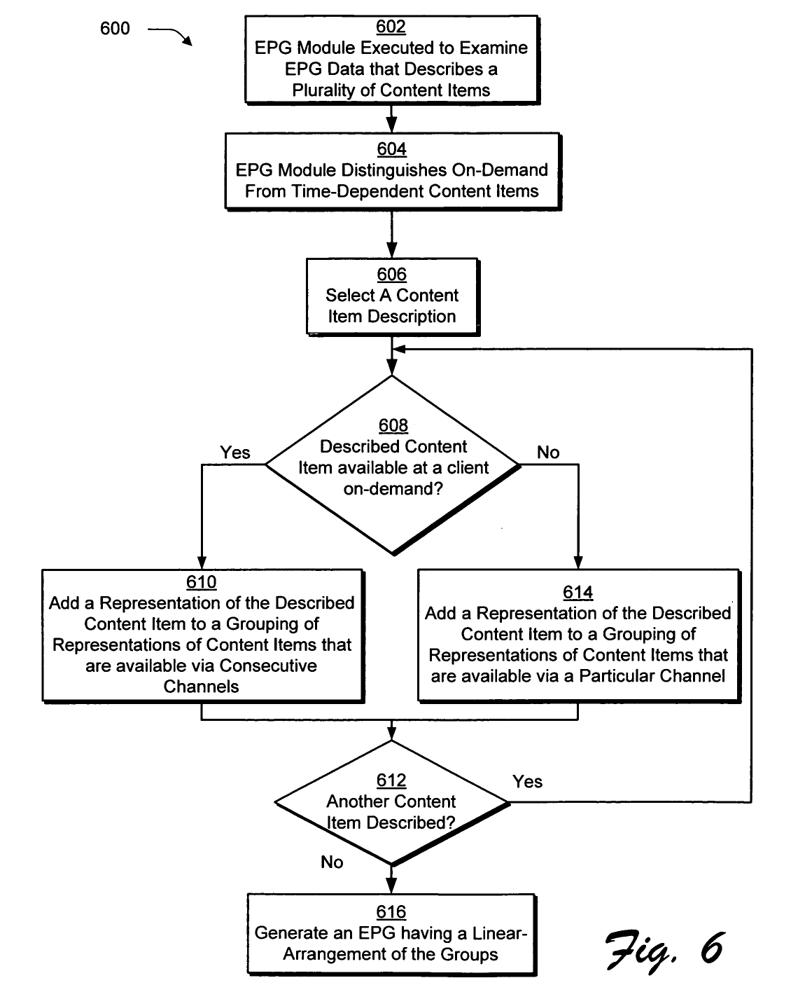

FIG. 6 is a flow diagram depicting a procedure 600 in an exemplary implementation in which an EPG is generated having representations that are grouped based on an output type of the represented content item. An EPG module is executed to examine EPG data that describes a plurality of content items (block 602). For example, the EPG data may describe content items that are available from a head end, such as television programs, VOD, PPV movies, remote application processing, remote video games, NDVR content, and so on. The EPG data may also describe content items that are available locally at a client, such as locally-stored television programs as previously described in the DVR example, locally-available applications (e.g., video games, browsers, word processors, and so on), content available on a removable computer-readable medium (e.g., a digital video disc), locally-stored music, and so on.

The EPG module, through the examination (block 602), distinguishes on-demand content items from time-dependent content items as described in the EPG data (block 604). For example, the EPG module may locate a flag which indicates whether the described content item is available on-demand or at a particular time. In another example, the EPG module may examine the description to determine if the content item has a described start-time, and if so, is time-dependent for output by the client.

The EPG module, for instance, may select a content item description from the EPG data (block 606). The EPG module may then make a determination as to whether the content item is available at the client on demand (decision block 608). If so, a representation of the described content item is added to a grouping of representations of content items that are available via consecutive channels (block 610). For example, as shown in FIG. 3, channel 171 has a content item that is available on demand, which is illustrated as the game “Whist”. A representation of the game may be added to a group containing a representation of another on-demand content item that is available via a previous channel, such as the representations of “Poker” and “Whist” shown in the linear grouping 414 in the EPG 130 of FIG. 4. The EPG module may then determine whether another content item is described (decision block 612), and if so, determine if the other content item is available on demand (decision block 608). Thus, the EPG module may continue to add representations to the “on-demand” grouping, such as representations for “Canasta” and “Pinochle” as shown in the EPG 130 of FIG. 4.

If the selected content item is not available at the client on demand (decision block 608), the EPG module adds a representation of the described content item to a grouping of representations of content items that are available via a particular channel (block 614). For example, the EPG module may construct a grouping of representations of television programs, such as the linear groupings 402-406 of the EPG 130 of FIG. 4 to provide a channel lineup. Likewise, if another content item is described in the EPG data (decision block 612), the procedure 600 may continue until each content item is distinguished as on-demand or time dependent. Once each content item is so distinguished, the EPG module generates an EPG having a linear-arrangement of the groups (block 616). For example, as shown in the EPG 130 of FIG. 4, each of the groupings 402-420 includes representations which are arranged to define a line, each being generally parallel, one to another. Although columns are shown in FIG. 4, a wide variety of linear arrangements may be employed, such as rows, rays, vectors, and so on.

FIG. 7 is a flow diagram depicting a procedure 700 in an exemplary implementation in which representations of content items that match are interleaved for display in an EPG. EPG data 702 that describes a plurality of content items is obtained (block 704). The EPG data 702 is illustrated as describing three channels, illustrated as channels 140-142, each showing a PPV movie. The three channels, in combination, thus provide a staggered broadcast of the PPV movie beginning every half hour between 8:00 pm and 10:00 pm.

Content items (and more particularly descriptions of the content items) in the EPG data 702 that are available via consecutive channels are compared, one to another (block 706). If the compared content items match (decision block 708), an EPG 710 is configured to have interleaved representations of the matching content items (block 712). A determination may then be made as to whether another channel is described (decision block 714), and if so, the comparison is again performed (block 706). If another channel is not described (decision block 714), the configured EPG may then be output for rendering (block 716). For example, in the illustrated EPG data 702, each of the PPV movies match, one to another, and are available via consecutive channels that are available to a client. Therefore, the EPG 710 may be generated to have a representation of each PPV movie that are interleaved in chronological order. Thus, the EPG 710 may conserve display space by displaying the representations in a single linear grouping, instead of providing a separate grouping for each channel. The conservation of display space for the EPG 710 may then be utilized to show additional representations of content items, thereby optimizing the display of the EPG.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
distinguishing a plurality of on-demand content items from a plurality of time-dependent content items that are described in data; and
forming a plurality of linearly-arranged groupings, based on the distinguishing, for output in a user interface, wherein:
at least one said grouping includes representations of said time-dependent content items that are available via a particular channel; and
another said grouping includes representations of said on-demand content items that are available via a plurality of channels.

2. A method as described in claim 1, wherein:
each said on-demand content item is configured for time independent output; and
each said time-dependent content item is configured for distribution during a specific period of time.

3. A method as described in claim 1, wherein each of the plurality of linearly-arranged grouping is generally arranged in parallel, one to another.

4. A method as described in claim 1, wherein the plurality of on-demand content items are selected from the group consisting of:
a video-on-demand (VOD);
an application;
a digitally recorded video that is available locally at a client having digital video recorder (DVR) functionality;
audio-only content; and
a digitally recorded video that is available remotely at a head end having network digital video recorder (NDVR) functionality;.

5. A method as described in claim 1, wherein each said representation is selectable to cause an output of a corresponding said content item, when available.

6. A method as described in claim 1, wherein:
the data is electronic program guide (EPG) data;
the user interface is an EPG; and
at least one said content item is a television program.

7. A method as described in claim 1, wherein:
the data is electronic program guide (EPG) data; and
the plurality of linear groupings form rows or columns in a table.

8. One or more computer readable media comprising computer executable instructions that, when executed on a computer, direct the computer to perform the method of claim 1.

9. A method comprising:
obtaining electronic program guide (EPG) data describing a plurality of content items, wherein each said content item has a corresponding description;
identifying a plurality of said descriptions available via a first channel that match another plurality of said descriptions available via a second channel; and
configuring an EPG, based on the identifying, to include interleaved representations of said content items available via the first and second channels.

10. A method as described in claim 9, wherein:
the first and second channels are accessible by a client to output respective said content items;
the first and second channels are consecutively ordered for selection via the client.

11. A method as described in claim 9, wherein each said description available via the first channel matches, one to another.

12. A method as described in claim 9, wherein at least one said description available via the first channel does not match another said description available via the first channel.

13. A method as described in claim 9, wherein the interleaved representations of said content items available via the first and second channels are displayed concurrently with a representation of the first and second channels.

14. A method as described in claim 9, wherein the configured EPG, when displayed, includes:
the interleaved representations that are linearly arranged to define a dimension in the EPG; and
representations of said content items, available via a third channel, that are linearly arranged as generally parallel to the defined dimension.

15. A method as described in claim 14, wherein said content items available via the third channel have corresponding said descriptions which do not match:
the plurality of said descriptions available via the first channel; and
the other plurality of said descriptions available via the second channel.

16. A method as described in claim 14, wherein:
the EPG is arranged as a table;
the dimension is selected from a column or a row of the table.

17. One or more computer readable media comprising computer executable instructions that, when executed on a computer, direct the computer to perform the method of claim 9.

18. A method comprising:
identifying, in electronic program guide (EPG) data describing:
a first channel having a first plurality of descriptions of content items that match, one to another; and
a second channel having a second plurality of descriptions of content items that match, one to another; and
combining the first plurality of descriptions into a first representation and the second plurality of descriptions in a second representation for adjacent display in an EPG.

19. A method as described in claim 18, wherein:
the first and second representations are linearly arranged, one after another, to define a dimension in the EPG;
the EPG includes a third plurality of representations of content items available via a third channel; and
the third plurality of representations are displayable as generally parallel to the defined dimension.

20. A method as described in claim 19, wherein:
the EPG is arranged as a table;
the defined dimension is a column or a row of the table.

21. A method comprising as described in claim 18, wherein one or more said content items are television programs.

22. A method comprising as described in claim 18, wherein the first and second channels are consecutive.

23. One or more computer readable media comprising computer executable instructions that, when executed on a computer, direct the computer to perform the method of claim 18.

24. One or more computer readable media comprising computer executable instructions that, when executed on a computer, direct the computer to generate an electronic program guide (EPG) having a plurality of representations of a plurality of content items, wherein each said content item having an output that is time independent is represented by a single corresponding said representation in the EPG.

25. One or more computer readable media as described in claim 24, wherein a plurality of said representations is linearly arranged in the EPG.

26. One or more computer readable media as described in claim 25, wherein:
the generated EPG is configured as a table; and
the liner arranges forms a row or column of the table.

27. One or more computer readable media as described in claim 24, wherein one or more of said time independent content items is selected from the group consisting of:
a video-on-demand (VOD);
an application; and
a digitally recorded video that is accessible via a client.

28. One or more computer readable media as described in claim 24, wherein the computer is located at a head end.

29. One or more computer readable media as described in claim 24, wherein the computer is a client that is configured to receive at least one said content item from a head end.

30. A system comprising:
electronic program guide (EPG) data arranged according to a plurality of channels, wherein each said channel includes a plurality of descriptions of a plurality of content items; and
one or more modules that are executable to generate an EPG by:
finding matching said descriptions in consecutive said channels; and
representing the matching said descriptions in the consecutive said channels along a single dimension in the EPG.

31. A system as described in claim 30, wherein:
the EPG is arranged as a table;
the particular dimension is a column or a row of the table.

32. A system as described in claim 30, wherein one or more said content items are television programs.

33. A system as described in claim 30, wherein:
each of the matching said descriptions are represented by a respective one of a plurality of representations; and
the plurality of representations are linearly arranged along the single dimension.

34. A system as described in claim 30, wherein:
the EPG data is stored in a database at a head end; and
the one or more modules are executable by at least one server located at the head end.

35. A system as described in claim 30, wherein:
the EPG data is stored in a memory at a client; and
the one or more modules are executable by the client.

36. A computing device comprising:
a processor; and
memory configured to maintain one or more modules that are executable on the processor to generate an electronic program guide (EPG) having:
a first grouping of representations of a plurality of content items, wherein each said representation in the first grouping is suitable for identifying a time and a channel for obtaining a represented said content item; and
a second grouping of representations of another plurality of content items, wherein each said representation in the second grouping is suitable for identifying a channel but not a specific time for obtaining a represented said content item.

37. A computing device as described in claim 36, wherein the first and second groupings are concurrently displayable in the EPG.

38. A computing device as described in claim 36, wherein at least one said content item corresponding to at least one said representation in the second grouping is configured for time independent output by a client.

39. A computing device as described in claim 38, wherein the at least one said content item is selected from the group consisting of:
a video-on-demand (VOD);
an application; and
a digitally recorded video that is accessible via a client.

40. A computing device as described in claim 36, wherein at least one said content item corresponding to at least one said representation in the second grouping is configured for time dependent output by a client and has a generic said description.

41. A computing device as described in claim 40, wherein the at least one said content item is a regularly repeating television program that is broadcast via a single channel.

42. A computing device as described in claim 36, further comprising a network transmitter for transmitting the generated EPG to a client over a network.

43. A computing device as described in claim 36, further comprising a network receiver for receiving at least one said content item from a head end over a network.
